(19) United States
(12) Patent Application Publication
(10) Pub. No.: US 2026/0105790 A1
(43) Pub. Date: Apr. 16, 2026

(54) ARTIFICIAL-INTELLIGENCE-BASED VEHICLE ROAD LOAD ENERGY PREDICTION METHOD

(71) Applicants: HYUNDAI MOTOR COMPANY, SEOUL (KR); KIA CORPORATION, SEOUL (KR)

(72) Inventor: Hyun Seung Song, Hwaseong-si (KR)

(73) Assignees: HYUNDAI MOTOR COMPANY, SEOUL (KR); KIA CORPORATION, SEOUL (KR)

(21) Appl. No.: 19/225,207

(22) Filed: Jun. 2, 2025

(30) Foreign Application Priority Data
Oct. 11, 2024 (KR) 10-2024-0138279

(51) Int. Cl. G07C 5/08

(52) U.S. Cl. CPC G07C 5/0808

(57) ABSTRACT

An artificial-intelligence-based vehicle road load energy prediction method includes: collecting data including a vehicle specification, a vehicle road load test result, and an atmospheric condition; preprocessing the collected data; and selecting a parameter to be used for predicting road load energy based on an importance evaluation using artificial intelligence from the preprocessed data. The method also includes: training a road load energy prediction model using each of a plurality of machine learning algorithms based on the selected parameter; and evaluating performance of the trained road load energy prediction model for each used machine learning algorithm to select at least one final road load energy prediction model based on comparison between evaluation results.

### CROSS-REFERENCE TO RELATED APPLICATION

This application claims priority to and the benefit of Korean Patent Application No. 10-2024-0138279 filed in the Korean Intellectual Property Office on Oct. 11, 2024, the entire contents of which are incorporated herein by reference.

### BACKGROUND

### (a) Technical Field

The present disclosure relates to an artificial-intelligence-based vehicle road load energy prediction method. More specifically, the present disclosure relates to an artificial-intelligence-based vehicle road load energy prediction method for accurately predicting road load energy of a vehicle by utilizing artificial intelligence without conducting a test on an actual road.

### (b) Description of the Related Art

Reducing carbon emissions and improving fuel efficiency of vehicles are very important tasks in an automobile industry. It is essential to accurately measure a road load of a vehicle to solve such tasks. Generally, a coastdown test method is used.

There has been significant discrepancy between actual coastdown test results and predicted values. The performance of such models varies depending on the experience of engineers and the quality of test data, leading to limitations in their suitability and practical application. Additionally, physical-empirical models rely on different empirical formulas depending on a shape of the vehicle and environmental conditions, requiring repeated tests for the empirical formulas.

Such a road load parameter has uncertainty when driving conditions change, a new vehicle model is used, or there is no existing database data, and it is difficult to confirm universality of the model. In addition, the coastdown test has a disadvantage that it is difficult to secure a large amount of data in a short period of time in terms of time and cost.

### SUMMARY

The present disclosure provides an artificial-intelligence-based vehicle road load energy prediction method for collecting and analyzing various parameters affecting a road load based on a technical specification of a vehicle, a weather condition, and a road load certification test result to train an artificial intelligence prediction model by a supervised learning method, and predicting road load energy of the vehicle by using the trained prediction model.

An artificial-intelligence-based vehicle road load energy prediction method may include: collecting data including a vehicle specification, a vehicle road load test result, and an atmospheric condition; preprocessing the collected data; and selecting a parameter to be used for predicting road load energy based on an importance evaluation using artificial intelligence from the preprocessed data. The method may also include: training a road load energy prediction model using each of a plurality of machine learning algorithms based on the selected parameter; and evaluating performance of the trained road load energy prediction model for each used machine learning algorithm to select at least one final road load energy prediction model based on a comparison between evaluation results.

The collecting of the data including the vehicle specification, the vehicle road load test result, and the atmospheric condition may include collecting a vehicle road load test result obtained through a coastdown test.

The collecting of the data including the vehicle specification, the vehicle road load test result, and the atmospheric condition may further include collecting each of the vehicle specification including a vehicle weight, a tire type, and a vehicle body shape, and the atmospheric condition including an atmosphere temperature, a humidity, and a wind speed by real-time monitoring and an automated collection program.

The preprocessing of the collected data may include processing the collected data by using a data refinement technique including outlier removal, missing value processing, and data normalization.

The selecting of the parameter to be used for predicting the road load energy based on the importance evaluation using artificial intelligence from the preprocessed data may include selecting the parameter from the preprocessed data by using at least one of correlation analysis, main component analysis, and feature importance evaluation.

The selecting of the parameter to be used for predicting the road load energy based on the importance evaluation using artificial intelligence from the preprocessed data may include selecting at least one first parameter related to a rolling resistance, at least one second parameter related to an air resistance, at least one third parameter related to an inertial resistance, and at least one fourth parameter related to the atmospheric condition.

The training of the road load energy prediction model using each of the plurality of machine learning algorithms based on the selected parameter may include training the road load energy prediction model using each of a regression analysis algorithm, a decision tree algorithm, a random forest algorithm, a gradient boosting algorithm, and a neural network algorithm.

The evaluating of the performance of the trained road load energy prediction model for each used machine learning algorithm to select at least one final road load energy prediction model based on comparison between the evaluation results may include verifying the performance of the road load energy prediction model through cross-validation, mean squared error (MSE) evaluation, root mean squared error (RMSE) evaluation, and mean absolute percentage error (MAPE) evaluation.

The artificial-intelligence-based vehicle road load energy prediction method may further include periodically retraining the at least one final road load energy prediction model based on a vehicle specification, a road load test result, and a real-time atmospheric condition collected in real time.

The artificial-intelligence-based vehicle road load energy prediction method may further include predicting the road load energy in real time based on an input vehicle driving condition by using the at least one final road load energy prediction model.

The evaluating of the performance of the trained road load energy prediction model for each used machine learning algorithm to select at least one final road load energy prediction model based on comparison between the evaluation results may include selecting, as the at least one final road load energy prediction model, a first model using an eXtreme Gradient Boosting (XGBoost) algorithm for predicting the road load energy corresponding to a vehicle driving condition, and a second model using a random forest algorithm for estimating an influence of each parameter affecting the road load energy.

The artificial-intelligence-based vehicle road load energy prediction method may further include performing hyperparameter tuning for each of the first model and the second model.

An artificial-intelligence-based vehicle road load energy prediction method includes providing a road load energy prediction model trained using a plurality of machine learning algorithms based on a technical specification of a vehicle, an atmospheric condition, and a road load test result. The method also includes predicting road load energy corresponding to an actual input vehicle driving condition by using the road load energy prediction model.

The artificial-intelligence-based vehicle road load energy prediction method may further include estimating an influence of each of parameters affecting the road load energy by using the road load energy prediction model.

The providing of the road load energy prediction model trained using the plurality of machine learning algorithms based on the technical specification of the vehicle, the atmospheric condition, and the road load test result may include training the road load energy prediction model. The training of the road load energy prediction model may include: selecting a parameter to be used for predicting the road load energy based on the technical specification of the vehicle, the atmospheric condition, and the road load test result; and training a plurality of road load energy prediction models by using the plurality of machine learning algorithms based on the selected parameter. Additionally, the training of the road load energy prediction model may include: evaluating prediction performance of each of the plurality of road load energy prediction models; and selecting a final road load energy prediction model whose evaluated prediction performance is the highest.

The artificial-intelligence-based vehicle road load energy prediction method may further include periodically retraining the road load energy prediction model based on a vehicle specification, a real-time road load test result, and a real-time atmospheric condition collected in real time together with a prediction result for the road load energy corresponding to the actual input vehicle driving condition.

The plurality of machine learning algorithms may include an XGBoost algorithm and a random forest algorithm.

The technical specification of the vehicle comprises a vehicle weight, a tire type, and a vehicle body shape.

The atmospheric condition comprises an atmosphere temperature, a humidity, and a wind speed.

The road load test result is obtained through a coastdown test.

The artificial-intelligence-based vehicle road load energy prediction method, according to an embodiment of the present disclosure, may collect and analyze various parameters affecting a road load based on a technical specification of a vehicle, a weather condition, and a road load certification test result. As a result, a prediction model is generated by a supervised learning method, and road load energy of the vehicle based on a driving condition by using the generated prediction model is predicted.

The artificial-intelligence-based vehicle road load energy prediction method, according to an embodiment of the present disclosure, is accurate, reliable, fast, and flexible due to a prediction model trained using various road load parameters based on artificial intelligence.

### BRIEF DESCRIPTION OF THE DRAWINGS

The above and other features of the present disclosure are described in detail with reference to certain examples thereof illustrated in the accompanying drawings which are given herein below by way of illustration only, and thus are not limitative of the present disclosure, and wherein:

FIG. 1 is a flowchart of an artificial-intelligence-based vehicle road load energy prediction method according to an embodiment of the present disclosure;

FIG. 2 is a diagram illustrating a rolling resistance, an air resistance, and an inertial resistance, which are road load elements of a vehicle acting on an actual road;

FIG. 3A is a graph illustrating a road load of a vehicle based on speed;

FIG. 3B is a diagram of a speed profile simulating urban and highway modes;

FIG. 4 is a diagram illustrating factors affecting road load energy;

FIG. 5 is a graph illustrating performance of each algorithm of an initial model according to an embodiment of the present disclosure;

FIG. 6 is a diagram illustrating a random forest model and an eXtreme Gradient Boosting (XGboost) model selected through initial model performance comparison according to an embodiment of the present disclosure;

FIG. 7 is a table illustrating values of hyperparameters set to maximize the performance of the XGBoost model according to an embodiment of the present disclosure;

FIG. 8 is a diagram illustrating visualized values of hyperparameters of the XGBoost model according to an embodiment of the present disclosure;

FIG. 9 is a diagram illustrating a mean absolute percentage error (MAPE) for prediction accuracy of the XGBoost model according to an embodiment of the present disclosure;

FIG. 10 is a diagram illustrating prediction performance for a test set of a final road load energy prediction model according to an embodiment of the present disclosure;

FIGS. 11A and 11B are diagrams illustrating comparison between a result based on an existing road load test method and a prediction result of the road load energy prediction model according to an embodiment of the present disclosure; and

FIG. 12 is a diagram illustrating a computing device according to an embodiment of the present disclosure.

### DETAILED DESCRIPTION

Hereinafter, embodiments of the present disclosure are described more fully with reference to the accompanying drawings so as to be easily practiced by those having ordinary skill in the art to which the present disclosure pertains. As those having ordinary skill in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Throughout the present specification and the claims, unless explicitly described to the contrary, the word “comprise” and variations such as “comprises” or “comprising”, should be understood to imply the inclusion of stated elements but not the exclusion of any other elements. Terms including an ordinal number such as “first” and “second” may be used to describe various components, but these components are not limited by these terms. These terms are used only for the purpose of distinguishing one component from another component.

Terms such as “-unit”, “-er/or”, and “module” described in the specification refer to a unit that may process at least one function or operation described in the present specification, and may be implemented as hardware or circuitry, software, or a combination of hardware or circuitry and software.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus.

Hereinafter, embodiments of the present disclosure are described with reference to the accompanying drawings.

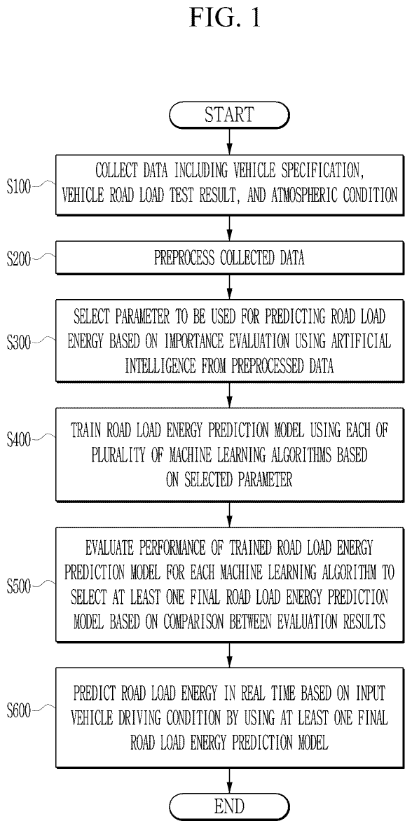

FIG. 1 is a flowchart of an artificial-intelligence-based vehicle driving resistance energy prediction method according to an embodiment of the present disclosure.

In FIG. 1, the artificial-intelligence-based vehicle road load energy prediction method may include collecting data including a vehicle specification, a vehicle road load test result (or a road load certification test result), and an atmospheric condition (Step S100).

The collecting of the data including the vehicle specification, the vehicle road load test result, and the atmospheric condition may include collecting data having a vehicle technical specification related to a road load of a vehicle, the atmospheric condition (or a weather condition), and a parameter of the road load test result by using an automated program.

In other words, the collecting of the data including the vehicle specification, the vehicle road load test result, and the atmospheric condition may include creating a data frame (DataFrame) with the collected data by using the automated program.

The vehicle specification may include a technical specification such as a vehicle weight, a tire type, or a vehicle body shape. The atmospheric condition may include a temperature, a humidity, and a wind speed. The road load test result may include a vehicle road load test result obtained through a coastdown test.

The artificial-intelligence-based vehicle road load energy prediction method may include preprocessing the collected data (Step S200).

The preprocessing of the collected data may include processing the collected data into a form suitable for analysis by using a statistical method and a data refinement technique (e.g., outlier removal, missing value processing, or data normalization). In other words, in the preprocessing of the collected data, the data is refined through a preprocessing process.

The artificial-intelligence-based vehicle road load energy prediction method may include selecting a parameter to be used for predicting road load energy based on an importance evaluation using artificial intelligence from the preprocessed data (Step S300).

For example, the selecting of the parameter to be used for predicting the road load energy may include selecting a key feature or parameter related to the road load by performing exploratory data analysis (EDA) based on domain knowledge.

In an embodiment, the selecting of the parameter to be used for predicting the road load energy based on the importance evaluation using artificial intelligence from the preprocessed data may include selecting parameters important for predicting the road load energy by using correlation analysis, principal component analysis, or feature importance evaluation based on the preprocessed data.

The selecting of the parameters may include evaluating an importance of each parameter by using a random forest machine learning technique.

The parameters may include at least one first parameter related to a rolling resistance, at least one second parameter related to an air resistance, at least one third parameter related to an inertial resistance, and at least one fourth parameter related to the atmospheric condition.

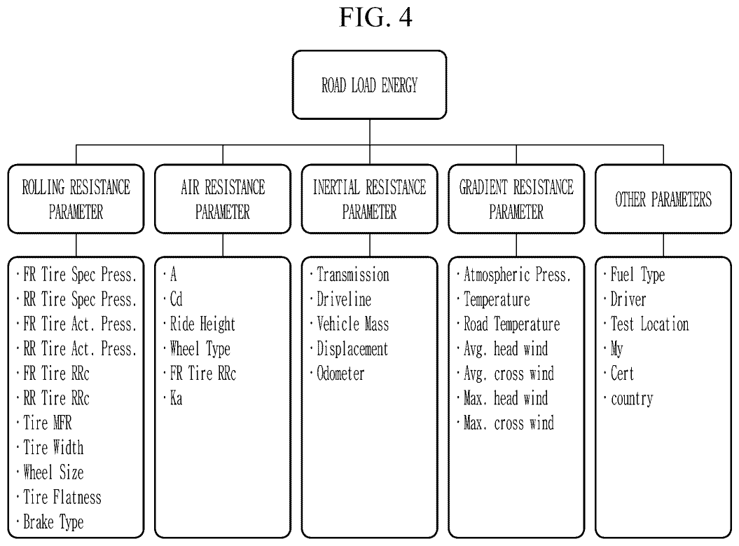

The first to fourth parameters according to an embodiment may be confirmed in FIG. 4.

The artificial-intelligence-based vehicle road load energy prediction method may include training a road load energy prediction model using each of a plurality of machine learning algorithms based on the selected parameter (Step S400).

The plurality of machine learning algorithms may include a regression analysis algorithm, a decision tree algorithm, a random forest algorithm, a gradient boosting (e.g., eXtreme Gradient Boosting (XGBoost)) algorithm, and a neural network algorithm.

In other words, the training of the road load energy prediction model using each of the plurality of machine learning algorithms may include generating a plurality of road load energy prediction models trained using each of the regression analysis algorithm, the decision tree algorithm, the random forest algorithm, the gradient boosting algorithm, and the neural network algorithm.

The artificial-intelligence-based vehicle road load energy prediction method may include evaluating performance of the trained road load energy prediction model for each used machine learning algorithm to select at least one final road load energy prediction model based on comparison between evaluation results (Step S500).

In other words, the artificial-intelligence-based vehicle road load energy prediction method may train an initial road load energy prediction model through regression analysis by using the selected parameters, and evaluate performance thereof.

The evaluating of the performance of the trained road load energy prediction model for each used machine learning algorithm may include verifying the performance of each road load energy prediction model through cross-validation, mean squared error (MSE) evaluation, root mean squared error (RMSE) evaluation, and mean absolute percentage error (MAPE) evaluation.

MSE, RMSE, and MAPE are representative performance indicators used to evaluate a regression model. Each indicator may be used to evaluate prediction performance of the road load energy prediction model by measuring a difference between a predicted value of the model and an actual value.

The selecting of the at least one final road load energy prediction model based on the comparison between the evaluation results may include selecting at least one final road load energy prediction model with the highest performance.

The final road load energy prediction model may predict the road load energy in a multivariable environment including the rolling resistance, the air resistance, the inertial resistance, and the atmospheric condition by applying an advanced machine learning technique such as multivariate regression analysis, an artificial neural network, random forest, or XGBoost.

The selected at least one final road load energy prediction model may include a first model using the XGBoost algorithm for predicting the road load energy corresponding to a vehicle driving condition, and a second model using the random forest algorithm for estimating an influence (or an importance) of each parameter affecting the road load energy.

Then, the artificial-intelligence-based vehicle road load energy prediction method may perform hyperparameter tuning to maximize the performance of the final road load energy prediction model.

In other words, the artificial-intelligence-based vehicle road load energy prediction method may perform the hyperparameter tuning to maximize road load energy prediction performances of the finally selected first model (XGBoost) and second model (random forest).

For example, the hyperparameter tuning may be performed using an Optuna library.

The Optuna library enables automatic hyperparameter tuning for a specified range. Optuna is a hyperparameter optimization library that helps optimize performance of a machine learning model through efficient exploration.

The artificial-intelligence-based vehicle road load energy prediction method may include predicting the road load energy in real time based on an input actual vehicle driving condition by using at least one final road load energy prediction model (Step S600).

For example, the artificial-intelligence-based vehicle road load energy prediction method may predict the road load energy corresponding to the vehicle driving condition in real time through a graphic user interface (GUI) program equipped with the final road load energy prediction model.

In an embodiment, the artificial-intelligence-based vehicle road load energy prediction method may include periodically retraining at least one final road load energy prediction model based on a vehicle specification, a road load test result, and a real-time atmospheric condition collected in real time together with the prediction result.

Data may be continuously collected and the retaining may be performed based on a technical specification of a new vehicle and a certification test result, thereby continuously improving prediction accuracy.

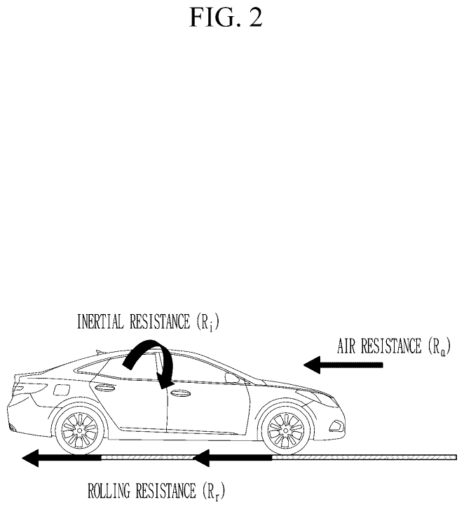

FIG. 2 is a diagram illustrating the rolling resistance, the air resistance, and the inertial resistance, which are road load elements of the vehicle acting on an actual road.

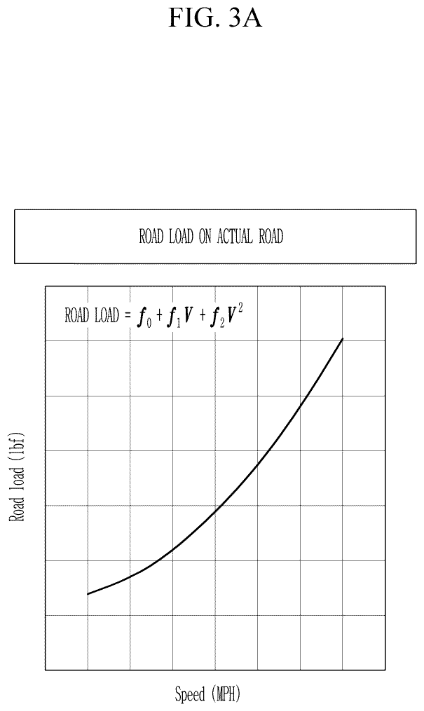

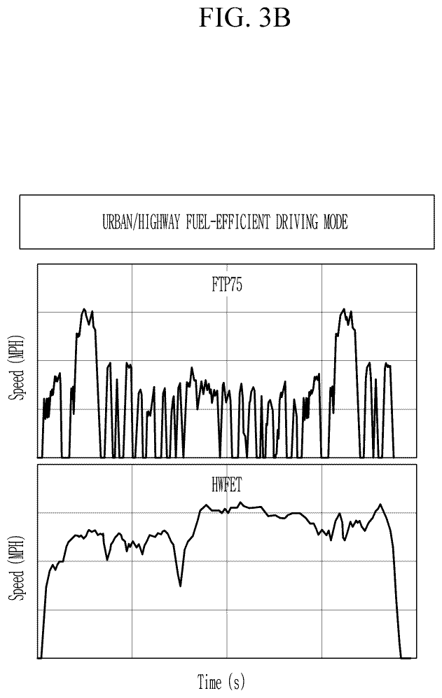

FIG. 3A illustrates a graph of a road load of the vehicle based on a speed measured through the coastdown test on the actual road. FIG. 3B is a diagram of a speed profile simulating urban and highway modes used to measure official fuel efficiency. The speed profile may be used to calculate the road load energy.

The following is described with reference to FIGS. 2, 3A, and 3B.

The road load of the vehicle largely may include the rolling resistance (Rᵣ), the air resistance (Rₐ), the inertial resistance (Rᵢ), and a gradient resistance (R_{g}). However, since the coastdown test is performed on a straight road without a gradient as illustrated in FIG. 2, it is assumed that there is no gradient resistance.

The rolling resistance may be a resistance that occurs when a tire comes into contact with a road surface and may be caused by tire deformation and friction between the tire and the road. The air resistance may be a resistance that occurs due to an interaction with the surrounding air when the vehicle is driven and may vary depending on a speed and shape of the vehicle, a wind speed, an air density, or the like. The inertial resistance may be a resistance that occurs due to a weight of the vehicle and rotation of a driving system and may be determined by the weight of the vehicle, a mass of a rotating body, and an acceleration.

However, calculating the road load by considering such elements one by one may be a very complicated process. Therefore, in a real road coastdown test to obtain the road load of the vehicle, the vehicle may be accelerated to a certain speed and then power may be cut off (N gear), the speed of the vehicle naturally decelerating may be measured over time, and the road load may be modeled as a second-order polynomial based on the speed as illustrated in FIG. 3A (left graph) and expressed as a road load coefficient.

However, it may be difficult to compare the road load of the vehicle with the coefficient alone. Therefore, in actual implementation, the road load energy for a fuel-efficient driving mode of each country may be calculated using the road load coefficient. In general, EFTP75 and EHWFET may be calculated in North America and South Korea, because in North America and South Korea, the official fuel efficiencies for urban and highway may be measured by driving in certain modes called federal test procedure 75 (FTP75) and highway fuel economy test (HWFET) using a chassis dynamometer as illustrated in FIG. 3B (right graph). The FTP75 is a mode that simulates an urban driving condition, and the HWFET is a mode that simulates a highway driving condition. Such road load energy may be obtained by numerically integrating the road load and instantaneous movement distance based on the speed profile of the corresponding mode.

Finally, composite road load energy that reflects both urban driving (weighted value: 0.55) and highway driving (weighted value: 0.45) may be calculated through weighting based on the energy calculation results of the FTP75 and the HWFET.

The composite road load energy calculated in this way may be an important indicator for evaluating the fuel efficiency of the vehicle, and in the present disclosure, the composite road load energy may be a target to be predicted by the road load energy prediction model trained through regression learning of machine learning.

In other words, the road load energy prediction model according to an embodiment predicts the composite road load energy in real time through artificial intelligence, thereby improving prediction performance by fast, accurate, and periodical retraining.

FIG. 4 is a diagram illustrating summarized factors affecting the road load energy. In particular, FIG. 4 shows the categories and types of the collected parameters related to the road load.

The artificial-intelligence-based vehicle road load energy prediction method may include collecting about 10 years of data regarding various parameters affecting the road load. Such parameters are the rolling resistance, the air resistance, the inertial resistance, the gradient resistance, and the atmospheric condition, based on the technical specification (e.g., the vehicle weight, the tire type, or the vehicle body shape) of the vehicle, the atmospheric condition (e.g., the temperature, the humidity, or the wind speed), and the road load test result. Additionally, the artificial-intelligence-based vehicle road load energy prediction method may include creating a data frame with the collected data by using the automated program.

In FIG. 4, the artificial-intelligence-based vehicle road load energy prediction method may include a preprocessing step of processing the collected data into a form suitable for analysis by applying the statistical method and the data refinement technique (e.g., outlier removal, missing value processing, or data normalization). In the preprocessing step, label encoding may be performed for a categorical variable, and MinMax scale is applied together with a continuous variable.

In addition, the artificial-intelligence-based vehicle road load energy prediction method may include confirming a correlation between the respective parameters. The confirming of the correlation between the respective parameters may be performed to avoid a multicollinearity problem. Multicollinearity may refer to a problem of a strong correlation between independent variables in regression analysis. The multicollinearity may have a problem of making estimation of a regression coefficient unstable and making interpretation of the model difficult.

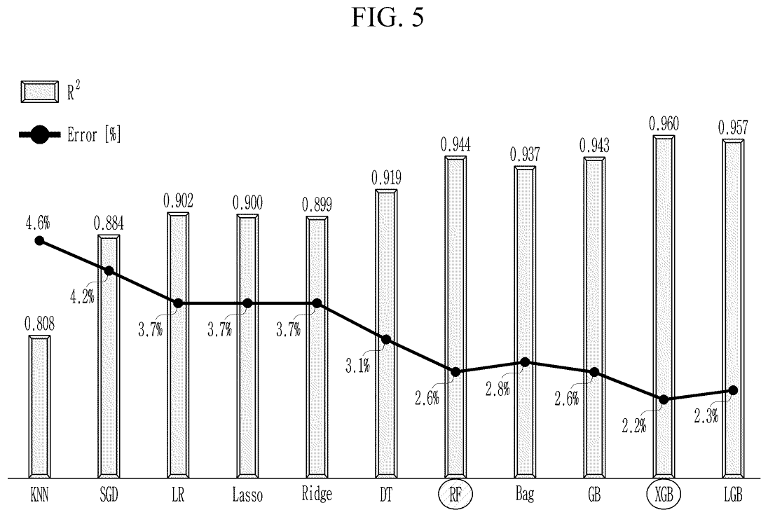

FIG. 5 is a diagram for confirming the performance of the initial model for each algorithm in order to find a machine learning algorithm suitable for the data with a preprocessed data set.

In machine learning, a regression algorithm may be used to model a relationship between a characteristic of the data and the target of the prediction model. There may be several types of regression algorithms, and each algorithm may be suitable for a specific type of data set and problem.

In an embodiment, the artificial-intelligence-based vehicle road load energy prediction method may include dividing the data into a train set and a test set in a ratio of about 8:2 to confirm an algorithm suitable for the corresponding preprocessed data set among several types of algorithms. The method may also include training the initial road load energy prediction model by a total of 11 supervised-learning-type regression algorithms (KNN, SGD, LR, decision tree (DT), random forest (RF), XGBoost, and the like), and evaluating the prediction performance.

In FIG. 5, an XGBoost model (XGB) has the best initial prediction performance as a result. Following the XGBoost model (XGB), an LGBoost model (LGB) and a random forest model (RF) have the next best performance, demonstrating excellent performance mainly in a tree-based ensemble structure.

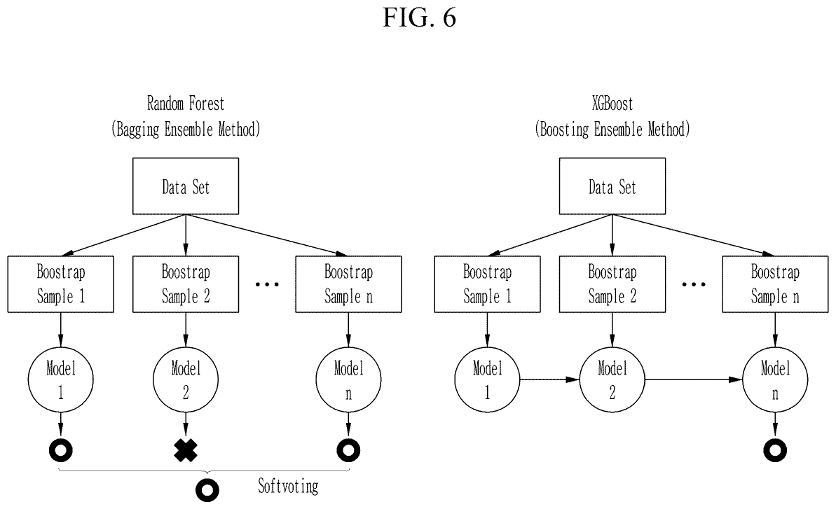

FIG. 6 is a diagram illustrating comparison of an algorithm structure between the random forest model and the XGboost model selected through the initial model performance comparison, and a difference.

In general, both of the random forest model and the XGBoost model may be powerful machine learning models that use ensemble learning techniques. However, the two models have several important differences.

As illustrated in FIG. 6, the random forest model may use bagging, which has a characteristic of preventing overfitting by independently producing tree models in parallel and averaging predictions of multiple trees. On the other hand, the XGBoost model may use a boosting technique, which sequentially generates trees and corrects an error of a previous tree. In addition, although parallel processing is possible, the XGBoost model may be slower than the random forest model due to a characteristic of sequential learning.

Finally, the artificial-intelligence-based vehicle road load energy prediction method may select and use both the XGBoost model and the random forest model. The XGBoost model may be used to confirm performance in predicting the road load energy, and the random forest model may be used to confirm an influence of the parameter affecting the road load energy based on a feature importance.

In other words, the artificial-intelligence-based vehicle road load energy prediction method may include training the road load energy prediction model by selectively using the XGBoost algorithm.

In addition, the artificial-intelligence-based vehicle road load energy prediction method may include training the road load energy prediction model for estimating the influence of each parameter affecting the road load energy by using the random forest algorithm.

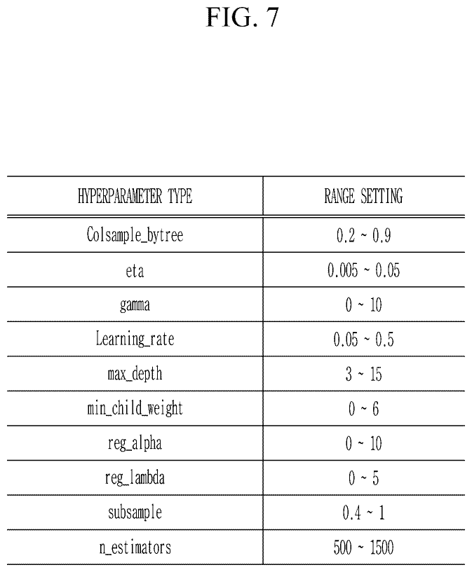

FIG. 7 is a diagram illustrating types and ranges of values of hyperparameters set to maximize the performance of the XGBoost model according to an embodiment. The table of FIG. 7 shows the types and ranges of the hyperparameters according to an example.

The artificial-intelligence-based vehicle road load energy prediction method may include performing the hyperparameter tuning to maximize the road load energy prediction performances of the finally selected XGBoost model and random forest model.

The hyperparameter tuning may be performed using the Optuna library, and the Optuna library may automatically perform the hyperparameter tuning for a specified range.

The artificial-intelligence-based vehicle road load energy prediction method may first perform an evaluation of an importance of the hyperparameter affecting the performance of the XGB model.

Then, the artificial-intelligence-based vehicle road load energy prediction method may include setting the types and ranges of the hyperparameters as illustrated in FIG. 7 and reflecting K-fold cross validation (cross validation) in training to improve a generalization ability during the training of the road load energy prediction model.

The artificial-intelligence-based vehicle road load energy prediction method may perform the training and evaluation of the model while slightly changing the hyperparameter for 1,500 times to find the most appropriate value of the hyperparameter.

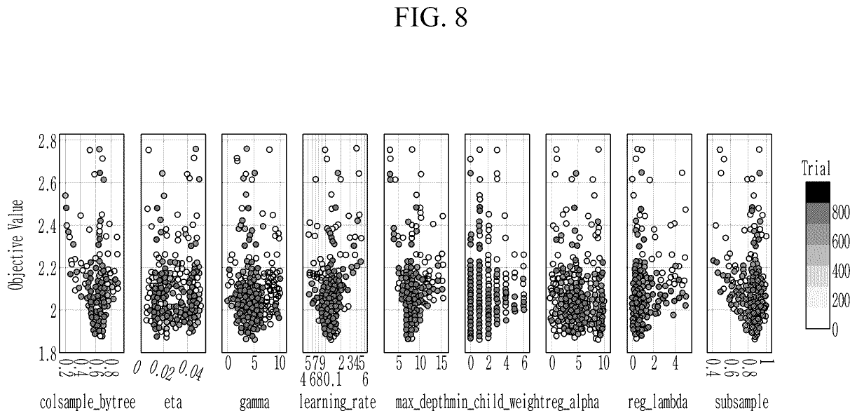

FIG. 8 is a diagram illustrating the selected values of the hyperparameter visualized while creating the road load energy prediction model about 1,500 times for the corresponding hyperparameter range of the XGBoost model.

FIG. 8 illustrates the visualized values of the hyperparameters selected during the training and evaluation of each road load energy prediction model. It may be confirmed that the respective hyperparameters have values that increase the prediction performance of the model in a specific region.

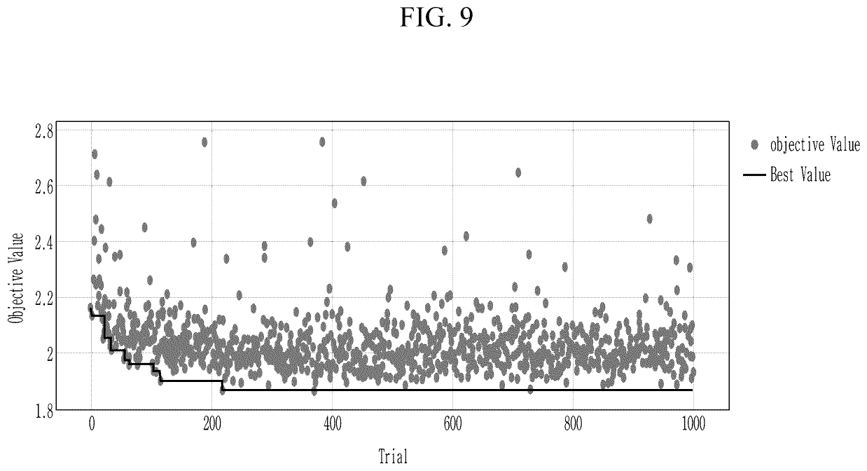

FIG. 9 is a diagram illustrating the MAPE that indicates how well each road load energy prediction model predicts the road load energy on average while the XGBoost model is performing the hyperparameter tuning.

FIG. 9 illustrates the MAPE between the road load energy predicted by the model and the actual road load energy. In this way, a model that maximizes the prediction performance of the model may be created.

The final road load energy prediction model may confirm average prediction performance of 1.81% based on the MAPE for a test dataset.

The artificial-intelligence-based vehicle road load energy prediction method may include performing the hyperparameter tuning in a similar way to the random forest model. The prediction performance may be slightly lower than that of the XGB (XGBoost) model, but the random forest model allows for identifying feature importance, determining which factors affects the road load energy.

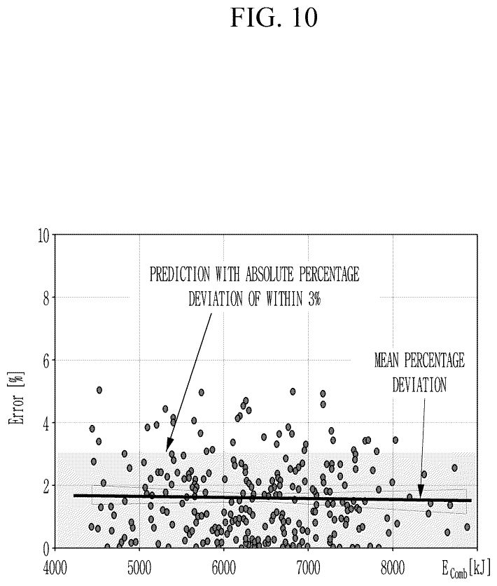

FIG. 10 is a diagram illustrating the prediction performance of the final road load energy prediction model for the test set.

FIG. 10 illustrates an absolute percentage error of a prediction result of an XGB regression model selected as the final road load energy prediction model for the actual composite road load energy of the test set.

In FIG. 10, the final road load energy prediction model predicts the target with a mean absolute percentage deviation of about 1.81% and shows the performance in prediction with an absolute percentage deviation of 3% or less for about 90% of the test sets.

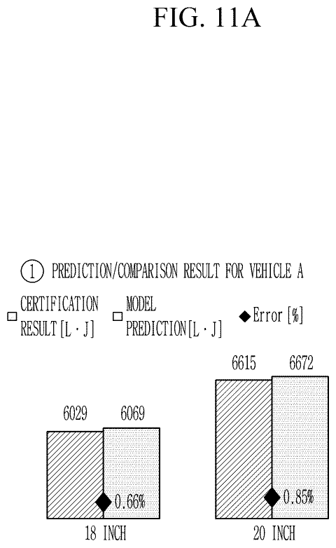

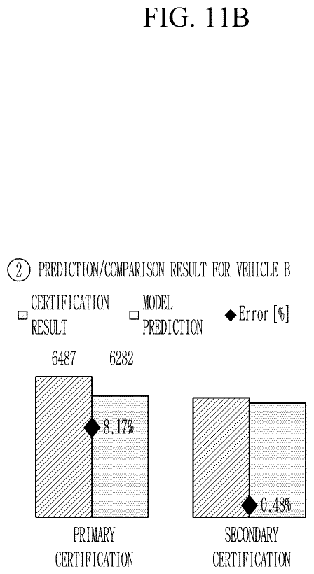

FIGS. 11A and 11B are diagrams illustrating a difference in prediction result between an existing road load test method and a method in which the road load energy prediction model according to the present disclosure performs prediction.

FIGS. 11A and 11B illustrate how the road load energy prediction model actually performs the prediction.

In FIGS. 11A and 11B, the XGB model was verified by first constructing a dataset through a separate road load certification test that is completely independent from the road load energy prediction model according to the present disclosure.

FIG. 11A shows the road load energy predicted by the artificial-intelligence-based road load energy prediction model according to the present disclosure in comparison with road load certification test results for Vehicle A with 18-inch and 20-inch wheels, respectively.

The road load energy prediction model according to an embodiment performs prediction within an error range of 1% or less with respect to the road load certification test results for 18-inch and 20-inch wheels, respectively.

FIG. 11B shows the road load energy predicted by the road load energy prediction model based on the artificial-intelligence-based vehicle road load energy prediction method of the present disclosure in comparison with road load certification test results for Vehicle B.

Referring to FIG. 11A, the predicted value of the road load energy prediction model has an error of about 3% or more in comparison with the road load certification test result.

However, in FIG. 11B, it may be seen that the prediction result of the road load energy prediction model has an error range of 0.5% or less in comparison with the road load certification test result.

The artificial-intelligence-based vehicle road load energy prediction method according to an embodiment of the present disclosure comprehensively analyzes various parameters such as the rolling resistance, the air resistance, the inertial resistance, and the atmospheric condition, which are elements of the road load, to enable more accurate, faster, and more reliable prediction of the road load energy as compared with an existing empirical method or a simple physical model.

In other words, the artificial-intelligence-based vehicle road load energy prediction method may accurately predict the road load energy of the vehicle without performing the cost-down test to measure the road load on an actual road.

In addition, the road load energy prediction model based on the artificial-intelligence-based vehicle road load energy prediction method is continuously retrained when a new vehicle is developed and a certification test is performed by using an artificial-intelligence-based machine learning algorithm utilizing actual certification test data.

Therefore, the road load energy prediction model provides flexibility to continuously improve the prediction accuracy. Such a process is part of the overall process including the automated data collection, the data preprocessing, the parameter selection, the model training, the model verification, and the new result prediction. As a result, the present disclosure maximizes efficiency and accuracy of the vehicle road load energy prediction model.

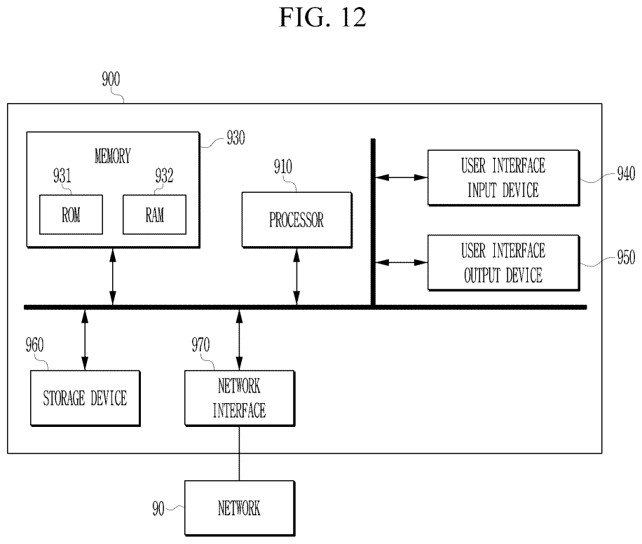

FIG. 12 is a diagram for describing a computing device according to an embodiment of the present disclosure.

Referring to FIG. 12, the artificial-intelligence-based vehicle road load energy prediction method according to the embodiments may be implemented using a computing device 900.

The computing device 900 may include at least one server that executes the road load energy prediction method.

The computing device 900 may include at least one of a processor 910, a memory 930, a user interface input device 940, a user interface output device 950, and a storage device 960 that communicate with one another via a bus. The computing device 900 may further include a network interface 970 that is electrically connected to a network 90. The network interface 970 may transmit or receive a signal with another entity via the network 90.

The processor 910 may be implemented in various types such as a micro controller unit (MCU), an application processor (AP), a central processing unit (CPU), a graphics processing unit (GPU), and a neural processing unit (NPU). The processor 910 may be any semiconductor device that executes an instruction stored in the memory 930 or the storage device 960.

The processor 910 may be configured to implement the functions and methods described above with reference to FIGS. 1 to 11.

The memory 930 and the storage device 960 may include various types of volatile or nonvolatile storage media. For example, the memory 930 may include a read only memory (ROM) 931 and a random access memory (RAM) 932. In the present embodiment, the memory 930 may be positioned inside or outside the processor 910, and may be connected to the processor 910 through various means that are already known.

In some embodiments, at least some of the components or functions of the artificial-intelligence-based vehicle road load energy prediction method according to the embodiments may be implemented as a program or software that are executed on the computing device 900, and the program or software may be stored in a computer-readable medium.

In some embodiments, at least some of the components or functions of the artificial-intelligence-based vehicle road load energy prediction method according to the embodiments may be implemented using hardware or circuitry of the computing device 900, or may be implemented as separate hardware or circuitry that may be electrically connected to the computing device 900.

Although the embodiments of the present disclosure have been described in detail hereinabove, the scope of the present disclosure is not limited thereto. In other words, several modifications and alterations made by a person having ordinary skill in the art to which the present disclosure pertains using a basic concept of the present disclosure as defined in the claims fall within the scope of the present disclosure.

### DESCRIPTION OF SYMBOLS

900: Computing device
910: Processor
930: Memory

What is claimed is:

1. An artificial-intelligence-based vehicle road load energy prediction method, the method comprising:
collecting data including a vehicle specification, a vehicle road load test result, and an atmospheric condition;
preprocessing the collected data;
selecting a parameter to be used for predicting road load energy based on an importance evaluation using artificial intelligence from the preprocessed data;
training a road load energy prediction model using each of a plurality of machine learning algorithms based on the selected parameter; and
evaluating performance of the trained road load energy prediction model for each used machine learning algorithm to select at least one final road load energy prediction model based on a comparison between evaluation results.

2. The method of claim 1, wherein collecting of the data comprises collecting a vehicle road load test result obtained through a coastdown test.

3. The method of claim 2, wherein collecting of the data comprises collecting each of the vehicle specification including a vehicle weight, a tire type, and a vehicle body shape, and the atmospheric condition including an atmosphere temperature, a humidity, and a wind speed by real-time monitoring and an automated collection program.

4. The method of claim 1, wherein preprocessing of the collected data comprises processing the collected data by using a data refinement technique including outlier removal, missing value processing, and data normalization.

5. The method of claim 1, wherein selecting of the parameter to be used for predicting the road load energy comprises selecting the parameter from the preprocessed data by using at least one of correlation analysis, main component analysis, and feature importance evaluation.

6. The method of claim 5, wherein selecting of the parameter to be used for predicting the road load energy comprises selecting at least one first parameter related to a rolling resistance, at least one second parameter related to an air resistance, at least one third parameter related to an inertial resistance, and at least one fourth parameter related to the atmospheric condition.

7. The method of claim 1, wherein training of the road load energy prediction model comprises training the road load energy prediction model using each of a regression analysis algorithm, a decision tree algorithm, a random forest algorithm, a gradient boosting algorithm, and a neural network algorithm.

8. The method of claim 1, wherein evaluating of the performance of the trained road load energy prediction model comprises verifying the performance of the road load energy prediction model through cross-validation, mean squared error (MSE) evaluation, root mean squared error (RMSE) evaluation, and mean absolute percentage error (MAPE) evaluation.

9. The method of claim 1, further comprising periodically retraining the at least one final road load energy prediction model based on a vehicle specification, a road load test result, and a real-time atmospheric condition collected in real time.

10. The method of claim 1, further comprising predicting the road load energy in real time based on an input vehicle driving condition by using the at least one final road load energy prediction model.

11. The method of claim 1, wherein evaluating of the performance of the trained road load energy prediction model comprises selecting, as the at least one final road load energy prediction model, a first model using an eXtreme Gradient Boosting (XGBoost) algorithm for predicting the road load energy corresponding to a vehicle driving condition, and a second model using a random forest algorithm for estimating an influence of each parameter affecting the road load energy.

12. The method of claim 11, further comprising performing hyperparameter tuning for each of the first model and the second model.

13. An artificial-intelligence-based vehicle road load energy prediction method, comprising:
providing a road load energy prediction model trained using a plurality of machine learning algorithms based on a technical specification of a vehicle, an atmospheric condition, and a road load test result; and
predicting road load energy corresponding to an actual input vehicle driving condition by using the road load energy prediction model.

14. The method of claim 13, further comprising estimating an influence of each of a plurality of parameters affecting the road load energy by using the road load energy prediction model.

15. The method of claim 13, wherein providing of the road load energy prediction model comprises training the road load energy prediction model, and wherein the training of the road load energy prediction model includes:
selecting a parameter to be used for predicting the road load energy based on the technical specification of the vehicle, the atmospheric condition, and the road load test result;
training a plurality of road load energy prediction models by using the plurality of machine learning algorithms based on the selected parameter;
evaluating prediction performance of each of the plurality of road load energy prediction models; and
selecting a final road load energy prediction model whose evaluated prediction performance is the highest.

16. The method of claim 13, further comprising periodically retraining the road load energy prediction model based on a vehicle specification, a real-time road load test result, and a real-time atmospheric condition collected in real time together with a prediction result for the road load energy corresponding to the actual input vehicle driving condition.

17. The method of claim 13, wherein the plurality of machine learning algorithms includes an eXtreme Gradient Boosting (XGBoost) algorithm and a random forest algorithm.

18. The method of claim 13, wherein the technical specification of the vehicle comprises a vehicle weight, a tire type, and a vehicle body shape.

19. The method of claim 13, wherein the atmospheric condition comprises an atmosphere temperature, a humidity, and a wind speed.

20. The method of claim 13, wherein the road load test result is obtained through a coastdown test.
